(19) United States
(12) Patent Application Publication
(10) Pub. No.: US 2004/0022312 A1
(43) Pub. Date: Feb. 5, 2004

(54) Lossless data compression

(76) Inventors: Simon R. Jones, Loughborough Leicestershire (GB); Jose Luis Nunez Yanez, Loughborough Leicestershire (GB)

Correspondence Address: NIXON & VANDERHYE P.C., 8th Floor, 1100 North Glebe Road, Arlington, VA, 22201, US

(21) Appl. No.: 10/208,006

(22) Filed: Jul. 31, 2002

(51) Int. Cl. H04B 1/66

(52) U.S. Cl. 375/240

(57) ABSTRACT

A method of lossless digital data compression is described for a digital signal comprising a plurality of symbols. The method comprises parsing the digital signal into tuples which terminate after an integer number of symbols or in response to the occurrence of a predetermined symbol in the digital data. The parsed tuple is then compared with a plurality of entries in a dictionary and, if a match is found, the tuple is replaced by a dictionary location. By parsing the signal prior to comparison with the dictionary, the effect of the granularity of the data on compression ratio is reduced. The invention also extends to a method of decompression, a compressor and decompressor and a compressed data signal.

This invention relates to lossless compression of data. The invention comprises a method and apparatus for the compression of data, a method and apparatus for the decompression of data and a signal of compressed data (be it stored in a computer memory, stored on a data carrier or carried as a signal on a communications network).

While lossy data compression hardware has been available for image and signal processing for some years, lossless data compression has only recently become of interest, as a result of increased commercial pressure on bandwidth and cost per bit in data transmission and data storage; also, reduction in power consumption by reducing data volume is now of importance.

The principle of searching a dictionary and encoding data by reference to a dictionary address are known, and the apparatus to apply the principle consists of a dictionary and a coder/decoder. Some compression systems based on the work of Lempel & Ziv utilise a “running” dictionary that comprises a copy of the incoming data stream for the previous n bytes. New data to be compressed is compared with the previously seen data and, if a match is found, is encoded using indicators for [position, length]. The length gives the amount of data (for example a number of bytes) that matches. Data that doesn't match is sent unaltered. To allow the decompressor to determine whether the compressed signal that it is receiving is compressed or uncompressed some sort of indication is required in the transmitted signal.

In Proceedings of EUROMICRO-22, 1996, IEEE, “Design and Performance of a Main Memory Hardware Data Compressor”, Kjelso, Gooch and Jones describe a novel compression technique, termed X-Match, which is designed to compress executable code which is stored in main memory and be suitable for high speed hardware implementation.

The X-Match compression technique maintains a dictionary that comprises a number of entries, each entry being the same length. When a match is found between one of the dictionary entries and the code to be compressed, the code is replaced by an index indicating the position of the matching entry in the dictionary. By compressing the executable code fewer memory pages will be required during execution, thus speeding processor operation. Compressor and decompressor have to be fast.

The X-Match lossless compressor maintains a dictionary of code previously seen, and attempts to match an element of code to be compressed with an entry in the dictionary. The code elements are called tuples and, because most microprocessors use 32 or 64 bit instructions, the tuples are chosen to be 32 bits (ie. 4 bytes) long. Non-matched tuples are provided at the output of the compressor unaltered. In order to improve efficiency, the X-Match compressor operates on partial matching. What this means is that, when two or three bytes in a 4 byte tuple match the corresponding bytes in a dictionary entry, it is identified as a “partial match”. Those bytes within the tuple that do not match are provided at the output unaltered and an indication of which bytes matched is included to permit accurate decompression.

The dictionary is preferably updated using Move To Front (MTF) and Least Recently Used (LRU) techniques. The MTF technique places the most recent tuple compressed in the dictionary after being processed. It is added at the front or top of the dictionary while shifting the other entries down. By encoding dictionary position using a dictionary code such as Phased Binary Code (PBC) an improvement in compression ratio is provided. The LRU technique discards those dictionary entries (assuming that the dictionary become full) that have been used least recently. This occurs in conjunction with the MTF technique because the last entry in the dictionary is discarded (once the dictionary is full).

In Proceedings of EUROMICRO-25, 1999, IEEE, “The X-MatchLITE FPGA-Based Data Compressor”, Nunez, Feregrino, Bateman and Jones describe the X-Match algorithm implemented in a Field Programmable Gate Array (FPGA).

In International Patent Application WO 01/56168, the contents of which are hereby incorporated by reference, Nunez and Jones describe the addition of Run Length Encoding (RLE) to the X-Match compression technique. This provides improved compression where a match consecutively occurs at the same position of the dictionary. By integrating the RLE algorithm into the X-Match dictionary its efficiency is improved.

In International Patent Application WO 01/56169, the contents of which are hereby incorporated by reference, Nunez and Jones describe an efficient technique for updating the dictionary which provides an improvement in compression speed.

The incorporation of these techniques, resulting in a compression system known as X-MatchPRO, have been shown to provide fast, efficient compression at rates comparable to those of other lossless compression techniques.

While the X-Match techniques provide excellent compression for processor executable code the compression ratio has been found to deteriorate when they are applied to HTML (HyperText Markup Language) code.

It is an object of the invention to provide a lossless data compression technique that addresses this disadvantage.

According to a first aspect of the invention there is provided a method of compressing digital data comprising a plurality of symbols, the method comprising parsing the digital data into tuples which terminate after an integer number of symbols or in response to the occurrence of a predetermined symbol in the digital data, comparing each tuple with a plurality of entries in a dictionary and replacing the tuple with a dictionary location in response to a match between the tuple and the entry at that dictionary location.

The inventors have identified that a large part of the reason for the deterioration in performance observed when compressing HTML, natural language or similar datasets is a failure of synchronisation between the start of words or groups of symbols of variable width in the incoming data stream and those in the dictionary. Another way of saying this is to state that the granularity of the data is generally one byte rather than 4 bytes. By parsing the incoming data in a particular way prior to comparing it with the dictionary entries, the number of matches between the incoming data stream and the dictionary is improved and this improves the compression ratio.

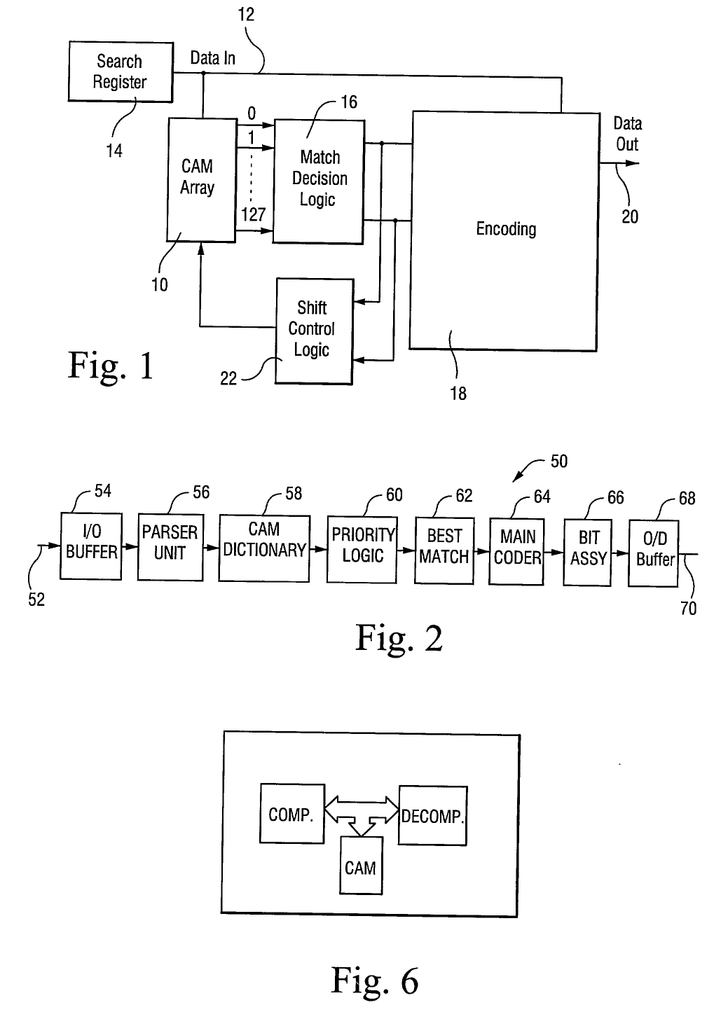

This will be described in greater detail hereinafter with reference to FIG. 1 of the accompanying drawings.

Embodiments of the present invention permit partial matching as discussed above for the X-Match paper. Also, it is preferred to compare the tuple only with those tuples in the dictionary that are of the same length. When the dictionary comprises CAM this will not be possible, as all of the entries in the dictionary will be compared. In this case, the output signals from the dictionary that relates to tuples of mismatched length will be disregarded in the further processing. The predetermined symbol will be a space character in many cases although other symbols may additionally or alternatively be used. Preferably the predetermined character is coded using very few bits and in a preferred embodiment is coded using only two bits. The Run length encoding and out of date adaption described in the earlier-identified WO specifications are also employed in a preferred embodiment.

According to a second aspect of the present invention there is provided a digital data compressor for compressing digital data comprising a plurality of symbols, the compressor comprising: a parser responsive to an integer number of symbols or to the occurrence of a predetermined symbol in the digital data for dividing the digital data into tuples, a dictionary for comparing a tuple with a plurality of entries and logic for replacing the tuple with a dictionary location in response to a match between the tuple and the entry at that dictionary location.

The present invention (and indeed X-Match more generally) is particularly susceptible to implementation in high-speed hardware such as a semiconductor chip. However, the compressor may equally be implemented on a field programmable gate array (FPGA) or otherwise.

According to a third aspect of the present invention there is provided a method of decompressing digital data representing a plurality of symbols, the method comprising determining a quantity of the digital data that corresponds to a tuple of the original data which tuple terminates after an integer number of symbols or in response to the occurrence of a predetermined symbol in the original data, and retrieving symbols from a dictionary in response to digital data indicating that a dictionary match occurred

According to a fourth aspect of the present invention there is provided a decompressor for decompressing digital data representing a plurality of symbols, the decompressor comprising logic for determining a quantity of the digital data that corresponds to a tuple of the original data which tuple terminates after an integer number of symbols or in response to the occurrence of a predetermined symbol in the original data, and logic for retrieving symbols from a dictionary in response to digital data indicating that a dictionary match occurred

According to a fifth aspect of the present invention there is provided a semiconductor integrated circuit (IC) containing a compressor in accordance with the second aspect of the present invention and a decompressor in accordance with the fourth aspect of the present invention. The semiconductor IC may be an Application Specific Integrated Circuit (ASIC) also containing other circuitry.

In an embodiment of the fifth aspect of the present invention the compressor and the decompressor use a common dictionary. This saves space on the IC but prevents it from compressing and decompressing data at the same time (duplex operation).

According to a sixth aspect of the present invention, there is provided a compressed data signal adapted to reconstitute original digital data comprising a plurality of symbols, the compressed data signal comprising a plurality of discrete sections each corresponding to an integer number of symbols in the original digital data, each discrete section of the compressed data signal comprising an indication of whether the corresponding symbols matched a dictionary entry, an indication of the number of symbols represented by the discrete section and any symbols not present in the dictionary.

FIG. 1 of the accompanying drawings shows a block schematic diagram of a prior art X-Match compressor.

The present invention will now be described, by way of non-limiting example, with reference to FIGS. 2 to 6 of the accompanying drawings, in which:

FIG. 2 shows a block schematic diagram of a compressor according to a first embodiment of the present invention,

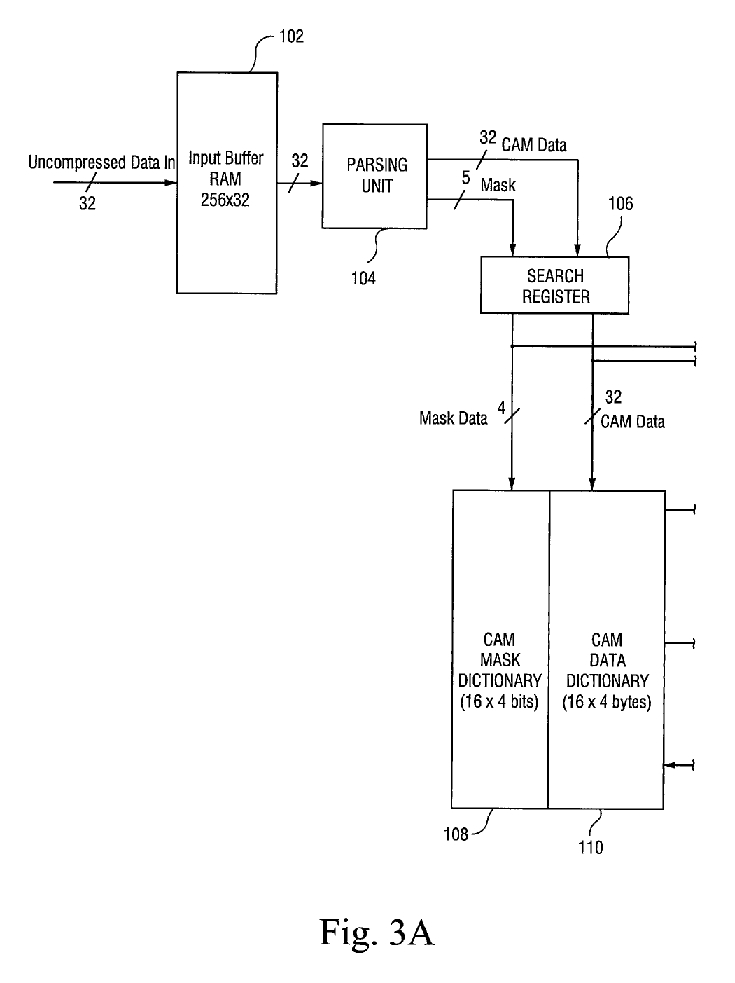

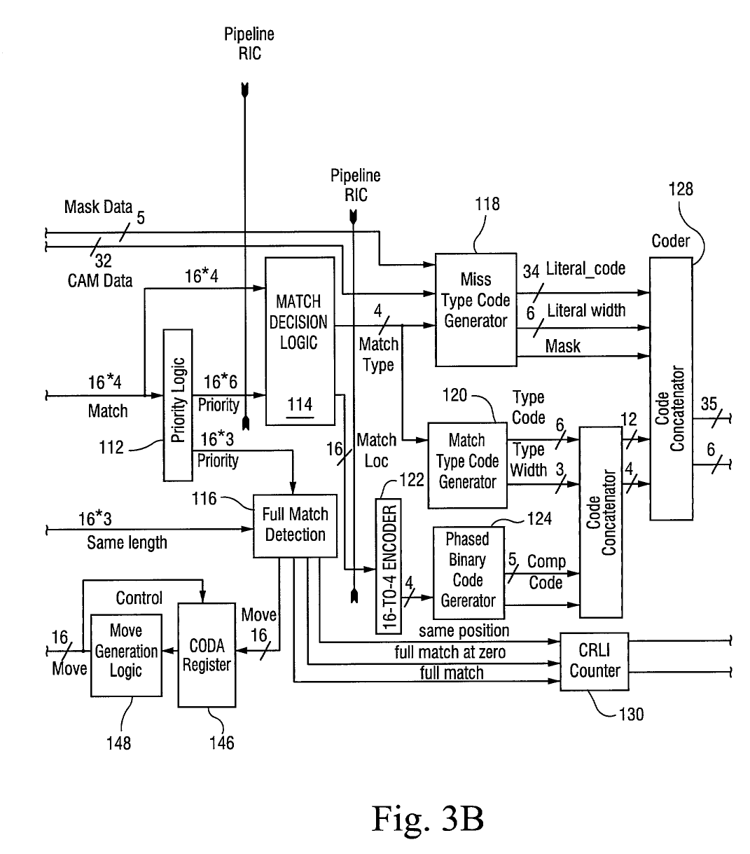

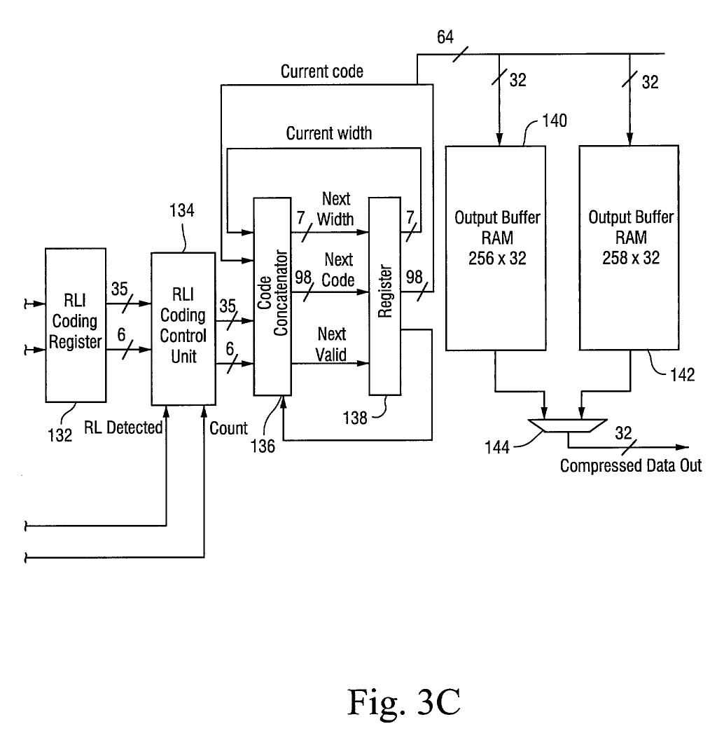

FIG. 3 shows a detailed block schematic diagram of a compressor according to a second embodiment of the present invention,

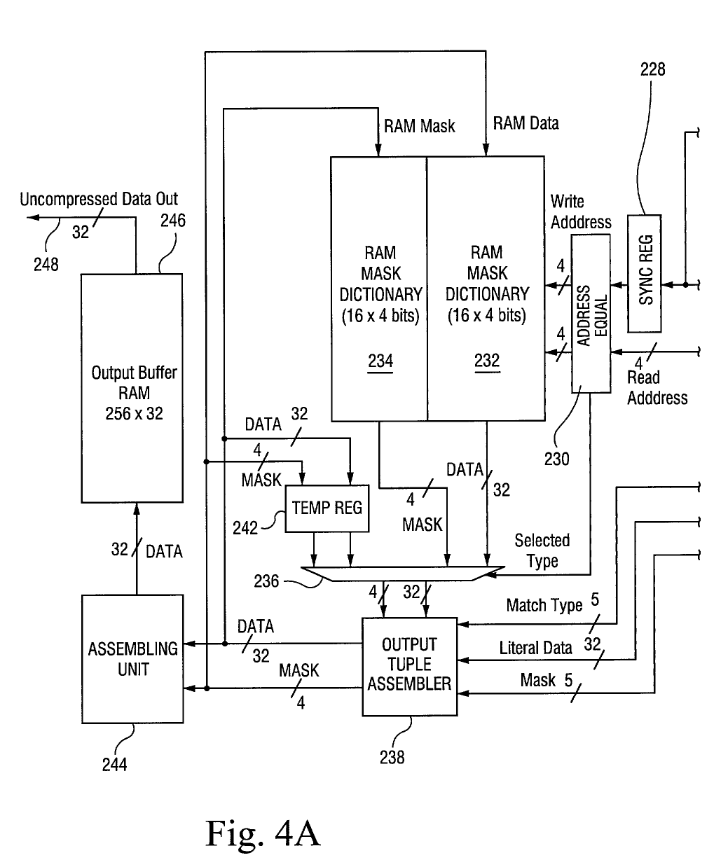

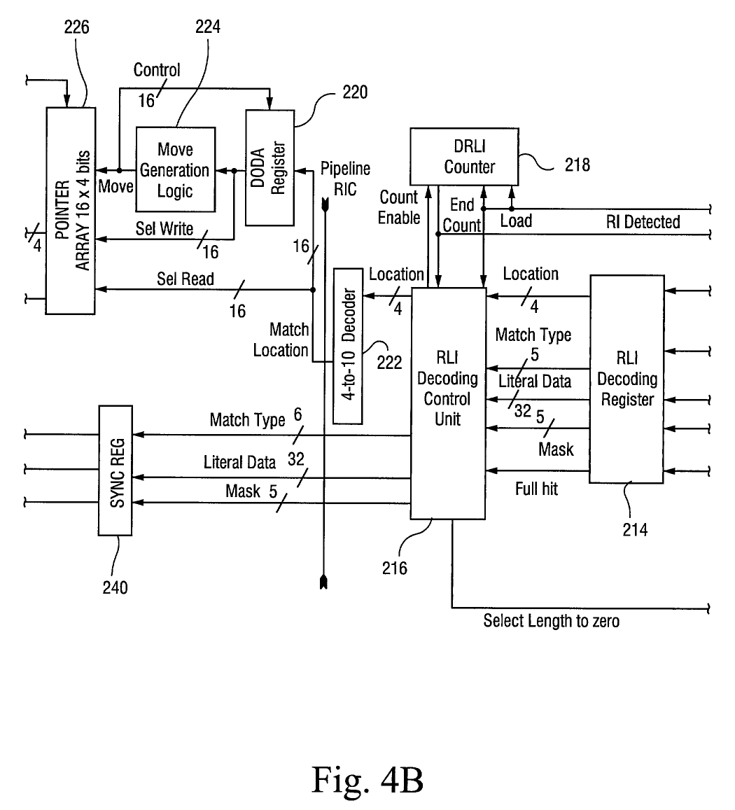

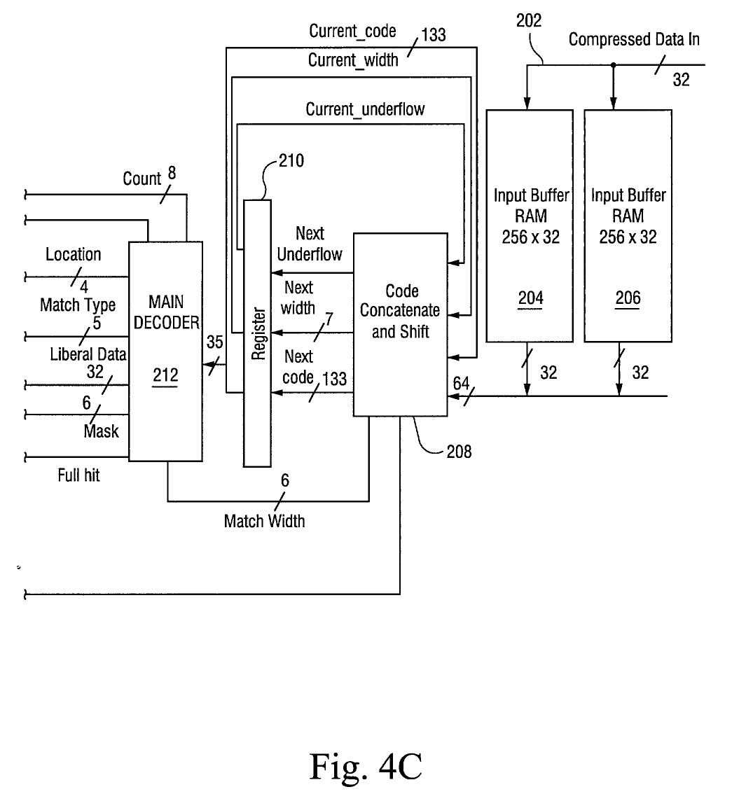

FIG. 4 shows a detailed block schematic diagram of a decompressor according to an embodiment of the present invention,

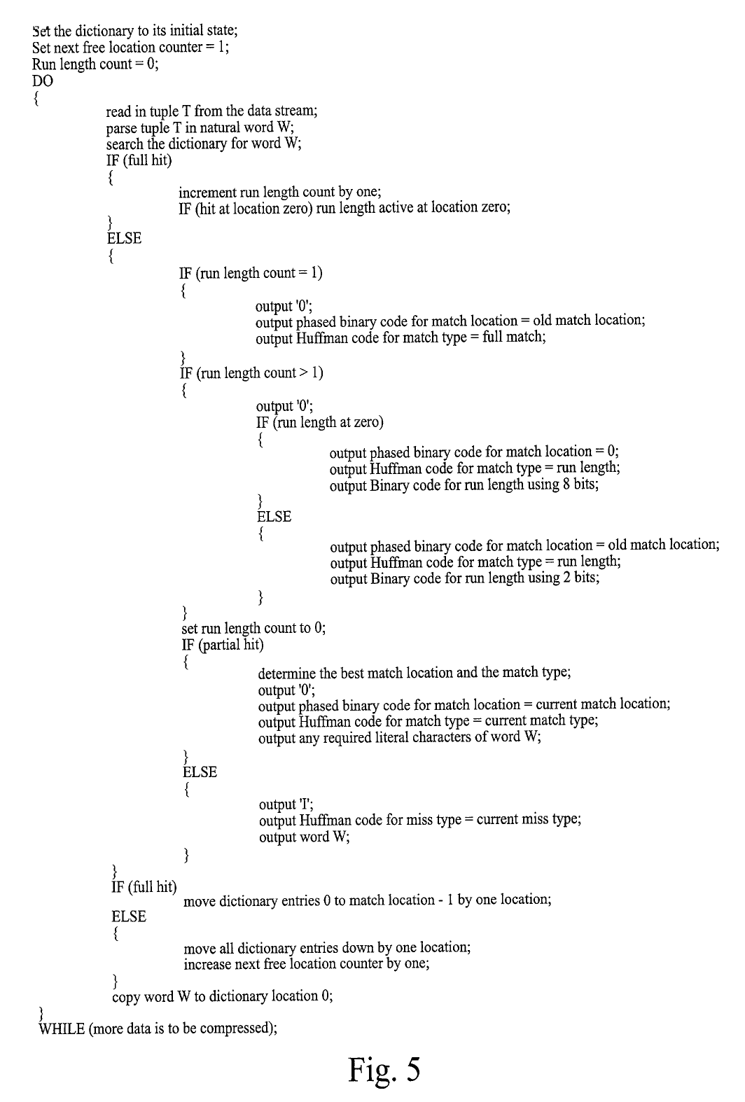

FIG. 5 shows a pseudocode listing for the compressor shown in FIG. 3,

FIG. 6 shows a block schematic diagram on a semiconductor integrated circuit containing both a compressor and a decompressor according to an embodiment of the present invention.

In the prior art as shown in FIG. 1, a dictionary 10 is based on Content Addressable Memory (CAM) and is searched by a four byte tuple 12 supplied by the search register 14. In the dictionary 10 each entry is also 4 bytes in width. With data elements of standard width, there is a guaranteed input data rate during compression and output data rate during decompression, regardless of data mix.

The dictionary stores previously encountered tuples; when a new tuple is used to search the dictionary and a match is found in the dictionary, the tuple is replaced by an index referencing the match location. CAM is a form of associative memory which takes in a data element and gives a match address of the element as its output. The use of CAM technology allows rapid searching of the dictionary 10, because the search is implemented simultaneously at every address at which tuples are stored.

In the X-Match compression technique, perfect matching is not essential. A partial match, which may be a match of 2 or 3 of the 4 bytes, is also replaced by the index referencing the match location in the dictionary. Of course the existence of a partial match must be coded to ensure correct decompression so a match type code MT is determined by Match Decision Logic 16. The unmatched byte or bytes are provided unmodified by the Encoding assembler 18. This use of partial matching improves the compression ratio when compared with the requirement of full matching of the tuple, but still maintains high throughput of the dictionary.

The match type indicates which bytes of the incoming tuple matched the corresponding bytes in the dictionary and which bytes have to be concatenated unaltered to the compressed code. There are 11 different match types that correspond to the different combinations of 2, 3 or all 4 bytes being matched. For example 0000 indicates that all the bytes were matched (full match) while 1000 indicates a partial match where bytes 0, 1 and 2 were matched but byte 3 was not and in this example byte 3 must be added unaltered to the output of the compressor. Since some match types MT are more frequent than others, a static Huffman code based on the statistics obtained through simulation is used to code them. For example, the most popular match type is 0000 (full match) and the corresponding Huffman code is 01. On the other hand a partial match type 0010 (the first, third and last bytes match) is more infrequent so the corresponding Huffman code is 10110. This technique improves the compression ratio.

If, for example, the search tuple is CAT_, and the dictionary contains the word SAT_at position 2, the partial match will be indicated in the format

(match/miss flag) (dictionary match location ML) (match type MT) (unmatched byte or bytes)

which in this example would be 022C, binary code 0 000010 0010 1010011, i.e. the capital C is not matched and is sent unaltered or literally to the coding part of the system.

The algorithm, in pseudo code, is given as:

Set the dictionary to its initial state;

DO

| | |
|---|---|
| { | read in tuple T from the uncompressed code; |

search the dictionary for tuple T;
IF (full or partial match)

| | |
|---|---|
| { | determine the best match location |
| | ML and the match type MT; |
| | output ‘0’; [match flag] |
| | output binary code for match location ML; |

output Huffman code for match type MT;
output any unmatched bytes (literals)
characters of tuple T; }

ELSE

| | |
|---|---|
| { | output ‘1’; [miss flag] |
| | output tuple T; } |

IF (full hit)

| | |
|---|---|
| { | move dictionary entries 0 to (ML-1) by |
| | one location;} |

ELSE

| | |
|---|---|
| { | move all dictionary entries down by |
| | one location;} |

copy tuple T to dictionary location 0; }

WHILE (more data is to be compressed);.

The best match location is determined on the basis of the smallest number of bits required in the compressed code.

The dictionary is arranged on a Move-To-Front (MTF) strategy, i.e. a current tuple T is placed at the front of the dictionary and other tuples moved down by one location to make space (regardless of whether the tuple T matched or not). If the dictionary becomes full, a Least Recently Used (LRU) policy applies, i.e., the tuple occupying the last location is simply discarded.

The coding function for a match is required to code three separate fields, i.e.

(a) the match location in the dictionary 10; uniform binary code where the codes are of the fixed length log 2 (DICTIONARY_SIZE) is used.

(b) a match type; i.e. which bytes of an incoming tuple match in a dictionary location; a static Huffman code is used.

(c) any extra bytes which did not match the dictionary entry, transmitted in literal form.

Referring again to FIG. 1, the match, or partial match or several partial matches to a given tuple T, are output by the dictionary 10 to a match decision logic circuit 16. This circuit supplies encoding equipment 18 which in turn provides a compressed output signal 20. Shift control logic 22 connected between the match decision logic 16 and the dictionary 10 provides shift signals to update the dictionary. The whole circuit can be provided on a single semiconductor chip.

The present inventors have determined the reason that the performance of the X-Match compressor deteriorates with certain data types. Imagine that the following phrase is to be compressed by the X-Match compressor. It is assumed that the dictionary is empty to begin with.

computer hardware and computer software

The data is divided (parsed) into tuples of 4 bytes in width, thus:

{comp} {uter} {har} {dwar} {e an} {d co} {input} {er s} {oftw} {are}

Each of these four byte tuples will be applied to the dictionary in turn. No matches will occur so each of the tuples will be provided unaltered in the compressor output data stream and also stored in the dictionary. No compression will be effected (indeed the length of the data will increase due to the insertion of the miss flags).

It will be seen, however, that there are a number of words and portions of words that recur within the phrase. There is therefore quite a lot of redundancy. Because the input phrase is simply divided into tuples of four bytes each means that this redundancy in the phrase is not exploited by the compressor to efficiently generate an output signal.

If the phrase were parsed as follows:

{comp} {uter} {hard} {ware} {and} {comp} {uter} {soft} {ware}

The repetition of the word “computer” and the tuple “ware” could be exploited to effect compression. Embodiments of the invention build on this principle.

In the following examples the delimiting or terminating symbol is assumed to be a space (ASCII code 32) but an alternative symbol or symbols could be used instead. This would be appropriate, for example, where the data to be encoded had a similar structure to the natural language used in these examples but which was not delimited by a space character.

It might be thought that the use of dictionary entries of less than the full possible width of the dictionary would cause compression rates to deteriorate when “pure” data, i.e. data having a granularity that matches the tuple width of the compressor. However, where a single delimiting character is used, this will occur only once every 256 bytes on average. Some coded tuples (and hence dictionary entries) will be prematurely shortened but these will be such a small proportion of the whole that it will not be significant.

FIG. 2 illustrates, in block diagram form, the principle of the present invention. A data compressor 50 accepts a data stream 52 to be compressed into an Input Buffer 54 which in turn provides a data to a Parser Unit 56. The parser unit slices up the data into tuples of a predetermined length or, in response to the presence of a parsing or termination symbol in the data, into tuples that end on this symbol. These tuples are then applied to a compression dictionary 58 whose output is coupled to priority logic 60. The priority logic is required because of the possibility of partial matches. There may be more than one partial match in the dictionary for a given tuple and so circuitry is required to rank the matches.

The output of the priority logic is coupled to best match decision logic that selects one of multiple possible matches (when they occur). The best match decision is provided to a main coder or match/miss coder 64. The main coder feeds bit assembly logic 66 which in turn feeds output buffer 68. Because the input data stream has been parsed as illustrated above the compression ratio improves markedly in respect of data that does not have a granularity that matches that of the tuple length.

The issue of whether it is appropriate for a given dataset to apply this parsing can be addressed in a number of ways. Firstly, the user of the compression algorithm (for example an application program) may specify the algorithm to be applied. Secondly, the variable tuple length algorithm may be applied until a non-textual character such as ASCII code 0 is detected in the incoming data stream. Once this character is detected then the fixed tuple length algorithm is applied. The decompressor can automatically detect this algorithm switch by applying the same rules as the compressor. It might be thought that the latter technique would simply delay the employment of the fixed length algorithm because the non-textual character is likely to occur in any data stream. However, this has been found not to be the case in practice. Human-readable data has been found to generally contain very few characters that would be interpreted as a machine code.

From the example given above it will be seen that there are a number of loose or “orphan” spaces that are separated by the parsing process. Whenever the length of a word is an integer multiple of the tuple length this will occur. The following embodiment has an efficient technique for efficiently compressing these orphan spaces.

If a space cannot be made part of the previous tuple it is sent on its own to the miss type code generator that adds a binary 11 (2 bits) to code the space. There is then explicit coding of the space in the fifth character position and since a byte is replaced by only 2 bits it is an efficient way of coding the spaces.

This principle can be extended to spaces occurring, for example, in the fourth character position.

For example, consider the two strings ABC_and ABCD_{—}

Where the underscore character represents a space. The first of these strings will be coded as for any four character tuple if a match occurs. If a miss occurs a miss type code generator will generate a code as follows:

1 (for a miss) [Huffman code of miss length] [ABC]

while for the second string the fifth character will be coded on its own as shown:

1 (for a miss) [different Huffman code] [ABCD]+1 (for a miss) [different Huffman code]

It is important to note that in the first case no space character is explicitly coded but in the second case the orphan space is explicitly coded as a miss. Since the occurrence of orphan spaces is quite common the number of bits used to code this event is ideally reduced as much as possible by proper selection of a short Huffman code. The selection of Huffman code can readily be made by the skilled person on the basis of tuple length, data characteristics and so on. An example is given below where the space has a Huffman code of only 1 bit (Underscore represents the space):

Miss type codes Table A

| Data Type | Data Length(bits) | Huffman code | Code Length(bits) |
|---|---|---|---|
| _{—} | 8 | 1 | 1 |
| a_{—} | 16 | 001 | 3 |
| ab_{—} | 24 | 0001 | 4 |
| abc_{—} | 32 | 0000 | 4 |
| abcd | 32 | 01 | 2 |

It is also important to note the distinction between this technique and that of the prior art compressors based on Lempel Ziv 77 and Lempel Ziv 78. These prior art compressors do replace variable lengths of incoming data with a single dictionary reference but the amount of data replaced by a dictionary reference each time is determined by the number of consecutive matching symbols between the incoming data and the contents of the dictionary. In the present invention, the variable length parsing operation is determined by the nature of the incoming data.

FIG. 3 shows an embodiment of a data compressor 100 according to the present invention which includes the above technique to more efficiently compress the “orphan” spaces. Before the description is commenced, it is worth noting that the diagram is complicated by the fact that we are not always processing a tuple of fixed length. The majority of the interconnections between circuit blocks within the compressor therefore comprise a bus that carries the data to process at various stages of compression and a further bus for carrying a signal indicating how many bits or bytes of the data bus are valid.

The width, in terms of the number of bits, of the paths between the elements of the circuit are denoted by a number adjacent to an oblique line across the data path. Items such as power supplies, clock circuits, clock lines and control circuitry are omitted for clarity. A data stream to be compressed is input on the left-hand side of the diagram already buffered to provide a 32-bit (4-byte) tuple. A compressed data stream, again as a 4 byte tuple is provided on the right hand side of the diagram for storage, transmission or whatever.

An input buffer 102 accepts a stream of data to be compressed from a data source on a 32 bit bus. Uncompressed data in the input buffer comprises 1 kilobyte (kB) of Random Access Memory arranged as 256 32-bit records to match the width of the input bus. The input buffer is included because the present embodiment (in contrast to the teachings of Kjelso et. al.) does not necessarily process 32-bits of data on each processing cycle. In this case the parts of the 4-byte tuple that have not been made part of the current word must form the start of the next word (tuple fix on sizes at 4-bytes but words variable result of parsing) to be compressed. The input buffer is further provided with a control line WAIT which is active to inform the data source when not to supply any further data. While a smaller buffer may be used, the provision of RAM on, for example, an Application Specific Integrated Circuit (ASIC) is easy and is, in general not a limiting factor on design While the data to be compressed is shown as arriving at the input buffer on a 32-bit wide line it could, naturally, be supplied as bytes, serially or whatever. The control of the data source and the nature of the connection to it may be provided by any suitable means.

The input buffer 102 provides 32-bits (4 bytes) of data to a parsing unit 104 whose purpose is to identify the parsing symbol (in this case a space character) and to reduce the length of those tuples that contain this symbol in the first, second or third byte of the tuple. The parsing unit 104 provides up to 32 bits of data for application to the Content Addressable Memory (CAM) and also a 5-bit wide Mask signal (explained below) to a search register 106. The purpose of the search register is to synchronise the operation of the compressor circuit. In the event that no match is found in the dictionary for either of these sequences then they will both be passed to a miss-type coder 118. The actual encoding of these two sequences will be discussed in detail with reference to the miss-type code generator 118 below.

The parsing unit 104 also generates a 5-bit wide Mask signal of which the 4 bits relating to the first four bytes supplied to the parsing unit are sent to a Content Addressable Memory (CAM) mask dictionary 108. A 5-bit mask is needed because the miss type code generator needs to know if the tuple contains a space or any other character as shown below:

TABLE B

| Data Type | 5-bit mask value |
|---|---|
| _{—} | 10000 |
| a_{—} | 11000 |
| ab_{—} | 11100 |
| abc_{—} | 11110 |
| abcd | 11111 |

The CAM mask dictionary 108 is the same length as the CAM data dictionary 110 and includes 1-bit corresponding to each of the bytes in the CAM data dictionary. In the diagram the CAM data dictionary is shown as containing 16 entries. In practice, a somewhat longer dictionary would be used, typically having 1024 entries, but a shorter dictionary is shown here to simplify the diagram. Roughly speaking complexity increases by a factor of 1.5 with each doubling of the length of the dictionary. The CAM mask dictionary contains a pattern of bits which indicates those bytes within the CAM data dictionary that contain valid data. If, for example, the CAM data dictionary contains an entry which is only 2 bytes wide then the corresponding entry in CAM mask dictionary will contain 1100 to indicate that only the first two bytes in the corresponding CAM data dictionary entry are valid.

CAM or Content Addressable Memory is associative memory that compares an input signal with all of the current entries in the memory and outputs a one bit match signal for each entry in the dictionary. The 64 bit Match signals (one bit for each byte in the CAM dictionary) are supplied to priority logic 112 and match decision logic 114.

Clearly, if the dictionary entry has been formed from a three-byte tuple then only the first three bytes of the dictionary entry should be compared with the tuple to be compressedThe present compressor only allows a partial match when a 4 byte tuple partially matches a dictionary entry. In other words a partial tuple cannot generate a partial match but a full tuple can generate a partial match in a dictionary location that contains fewer than 4-bytes valid.

The CAM also provides an output signal Same Length which is three bits wide for each dictionary entry. This carries the information as to whether the match on the bus Match is full because the length of the tuple applied to the CAM is the same as the dictionary entryThis signal is supplied to Full Match Detection circuit 116.

The outputs from the CAM Data Dictionary and the output from the Search Register 106 are then fed to a set of logic that generates full match, partial match and miss signals in dependence upon the output of the CAM Data Dictionary.

Where there is a full four byte match between the incoming tuple and one of the dictionary entries then a signal is provided on line Match bus to Priority Logic 112 and Match Decision Logic 114. The Priority Logic 112 has two output lines, the first labelled 16*6 Priority is connected to a second input to the Match Decision Logic 114 while the second labelled 16*3 Priority is connected to a Full Match Detection circuit 116. The Full Match Detection Circuit 116 is also connected to the Same Length bus from the CAM Data Dictionary. There are 6 different priorities because some match types have higher priority than others as illustrated below

A binary 1 indicates a match and a binary 0 a miss

Match type codes Table C

| | Match | | Huffman | Length |
|---|---|---|---|---|
| | type | Priority | code | (bits) |
| (full match) | 1111 | 1 | 1 | 1 |
| (3 MSB match) | 1110 | 2 | 010 | 3 |
| (3 LSB match) | 0111 | 3 | 000 | 3 |
| (any other 3 match) | 1101, 1011 | 4 | 001111, 001110 | 6 |
| (2 MSB match) | 1100 | 5 | 0010 | 4 |
| (any other 2 match) | 0110, 0011 | 6 | 001101, 001100 | 6 |

In practice matches such as 1001, 0101, 1010 proved, after extensive simulation, to be not sufficiently common and they do not get a Huffman code. This means that they get a null priority and are not allowed.

These priorities are assigned after extensive simulation and identification of which match types are more beneficial for compression.

Priorities 1, 2 and 5 could generate full matches if the search word matches in length the dictionary word. Such as finding a_in dictionary location 3 that contains a_. This will be identified as priority 5 (partial match of the 2 MSB) but the full match detection logic circuit 116 would upgrade this match to a full match using the signal 16*3 that contains priorities 1, 2 and 5 and the same length 16*3 signal coming from the CAM dictionary that indicates if there is a length match of 4, 3 or 2 bytes.

Full Match Detection circuit 116, as is its name implies, detects a full match and generates 4 output signals: a Move signal which comprises a number of bits equal to the number of dictionary entries and three signal bit flags Same Position, Full Match at Zero and Full Match. The three single bit flags are all concerned with Run Length Coding are supplied to CRLI counter 130. The Move signals are used for updating the dictionary and are supplied to CODA 146. The Compressor Out_Of_Date Adaption (CODA) logic is connected in a feedback loop with Move Generation logic 148 whose output is coupled to the CAM dictionary [WO 01/56169 should be referred to for more detail.

The Match Decision Logic 114 also provides a 16 bit wide signal Match Loc (match location) ML which comprises one bit for each dictionary entry to a 16-to-4 Encoder 122. This encoder provides a 4 bit signal to a Phased Binary Code Generator 124 which in turn provides a 5 bit Comp Code signal to a Code Concatenator 126. The Phased Binary Code is used to reduce the number of bits devoted to dictionary match location during the phase of operation during which the dictionary is not yet full. An additional signal line indicates the width of the Phased Binary Code. The Code Concatenator 126 is further supplied by the 6 bit Match Type Code signal and a 3 bit Type Width signal from the Match Type Code Generator 120 which provides a Huffman coded output The output of the Code Concatenator 126 is a 11 bit signal (max is 1 bit for the miss or match, 4 bits for the location, 6 bits for the type=11) including a Match Code and a Match Type with a 4 bit signal indicating the number of valid bits in the main output signal code_a

A Miss Type Code Generator 118 receives the Mask Data signal and the CAM Data signal from the Search Register 106 as well as a 4 bit wide signal Match Type from the Match Decision Logic 114. The Match Type signal is also supplied to a Match Type Code Generator 120.

The 34 bit literal code contains the literals plus miss type needed to code a miss. A worst case is a 34 byte literal, ie. the original 32 bits of CAM data from the search register 106 plus 2 bits to indicate the type of miss. Refer to previous table A with types of misses The 6 bit literal width indicates which part of the literal_code signal are valid.

The match type code generator 120 receives the four bit Match Type signal from Match Decision Logic 114. The Match Type Code Generator converts this four bit signal into a Huffman code of up to 6 bits as seen in the previous table match types C and provides this as a Type Code signal to code concatenator 166. Match Type Code Generator 120 further generates a Type width signal 3 bits wide which indicates how many of the 6 bits in the Type Code signal are valid Huffman codes. (Because of the nature of Huffman code the code concatenator 126 could derive the Type width from the Type Code but this is not necessary since the Match Type Code Generator can readily supply this information)

The phased binary code generator 124 converts the binary coded Match Loc signal into Phased Binary Code. The purpose of the phased binary code generator is to encode the dictionary match location using the fewest number of bit while the dictionary is filling up. Code concatenator 126 converts the Match Type Huffman code and the dictionary location phased binary code into an 11 bit signal Code_a which is provided to a code concatenator 128. The code concatenator 126 also provides a 4 bit wide signal to code concatenator 128 which identifies which of the 11 bits in the code_a signal are valid.

A further Code Concatenator 128 is provided with signals as follows

34 bit Literal Code from the Miss Type Code Generator

6 bit Literal Width from the Miss Type Code Generator

1 bit Miss flag from the Miss Type Code Generator

11 bit code_a from the Code Concatenator 126

4 bit signal indicating the valid width of the code_a from the Code Concatenator 126

The Code Concatenator 128 provides a 35 bit wide signal code_b. And a 6 bit wide signal indicating the bits of the code_b Signal which are valid to a RLI Coding Register 132 which in turn provides a 35 bit wide signal code_c and a 6 bit wide signal indicating the bits of the code_c Signal which are valid to a RLI Coding Control Unit 134. 35 bits are used because in a worst case 34 bits can be generated from the miss type code generator and 1 bit must be added to indicate a miss, generating a 35 bits signal.

The Coding Control Unit 134 also receives an RL Detected signal and a Count signal from a CRLI Counter 130.

The CRLI Counter 130 detects series in the incoming data stream. Because the CAM Dictionary operates on a Move-to-Front basis (for full matches), the first occurrence of a particular tuple will cause the dictionary entry for that tuple to be at the front of the dictionary. This will be the case whether the tuple matched an entry in the dictionary or whether a new entry was formed when the tuple was received. A succession of identical tuples in the incoming data stream will cause a series of full matches at dictionary position zero to occur and the CRLI counter will count the number of such matches. The RLI Coding Control Unit acts accordingly to encode data (when appropriate) as a run length code to provide further improvements in compression rate. This RLI unit is extended in the current embodiment to be sensitive to repetitions of matches not only at the top of the dictionary but also to repetitions of matches at any other location. The objective is to efficiently code in a single output long words that extend over several dictionary locations. For example the word International will be distributed over 4 dictionary locations as {Inte} {rnat} {iona} {al_}. The MTF maintenance strategy will generate several matches in the same location larger than zero if the word International is found again. The extended RLI coder will produce a single output indicating the location and the number of repeated matches. As the previous patent application WO 01/56168 describes 8 bits are used to code repetitions of matches at location 0 so a maximum of 255 can be coded in a single run. The extension introduced in this embodiment uses only 2 bits to code repetitions on matches at location larger than 0 so a maximum of 5 repetitions (4 codes to code 2, 3, 4 or 5 repetitions) can be coded in a single run. This is done to improve compression since words do not usually extend further than 5 dictionary locations.

The principles of Run Length Encoding are well known. For further information the reader is directed to the Applicant's International Patent Application WO 01/56168 incorporated by reference previously.

The RLI Coding Control Unit 134 provides a 35-bit signal code_d and a 6-bit wide signal indicating the bits of the code_d Signal which are valid to a further Code Concatenator 136 which outputs a 7 bit Next Width signal, a 98 but Next Code signal and a 1 bit Next Valid to a Register 138. The Register 138 provides a 7 bit Current Width signal, a 98 bit Next Code signal.

The output buffers are provided because the nature of the compression algorithm means that the rate of output data varies. The buffers shown generate 32 bit wide data because this is a common bus width in data processing. Other bus widths can, of course, be readily accommodated.

Of the 98 bits that comprise the Current Code signal, the most significant 64 bits are provided in a bus to a pair of 32 bit wide Output Buffers 140, 142. The output buffers are provided to break the compressed data into 32 bit wide data for storage or transmission. They take the 64 bit output and transform it into a 32 bit output providing a 32 but wide output signal

Finally, there are two vertical lines on FIG. 3 marked Pipeline ROC and Pipeline R0C. Pipelining in this embodiment is used not only to improve timing but also to have the required delay for the RLI coder The output (compressed) data must be delayed until the RLI coder has determined whether the incoming data includes a run. If it does then the RLI coder provides the output while if it doesn't the main compressor circuitry provides the output delayed by two compression cycles.

FIG. 5 shows a pseudocode listing for the above-described embodiment, which gives further explanation of the operation of the Miss Type Coder and the RLI.

FIG. 4 shows a block schematic diagram of a decompressor 200 in accordance with an embodiment of the invention. The flow of data in the diagram proceeds from right to left as decompression is performed. While the function of the decompression are in many ways the reverse of the compressor and are implicit from the structure and operation of the compressor, some further explanation follows.

Compressed data is provided on 32 bit bus 202 to a pair of Input Buffers 204, 206. These buffers are arranged as 256 times 32 bit wide Random Access Memory (RAM). The length of the buffers is not important but the arrangement is because 64 bits of data must be available before operation starts and ensure that the decompression circuit has enough data upon which to operate, even if the incoming compressed data is not arriving at a consistent rate. Outputs from these buffers are combined into a 64 bit wide bus that is supplied to a Code Concatenate and Shift unit 208. The Code Concatenate and Shift Unit provides a single bit Next_Underflow signal, a seven bit Next_Width signal and a 133 bit Next_Code signal to a register 210. The register 210 delays these signals by one decompression cycle and provides a single bit Current_Underflow signal, a seven bit Next_Width signal and a 133 Current_Code signal.

The main loop needs to be 133 bits wide because the operational mode of the disassembly logic that is designed to extract the maximum parallelism out of the operations of decoding, shifting out old data and concatenating new data. This is a critical path in the design so to wait until the decoding operation is complete to shift old data out and concatenated new data is not preferred.

New data (64 bits) must be concatenated in parallel to a decoding operation before the number of decoded bits is known to improve speed. The new data being concatenated is not available for the current decoding operation. If the current decoding operation consumes a maximum of 35 bits at least 35 bits must be left in the loop so the next decoding operation can start before new data has been added. If only 35+34 bits are in the loop the current decoding operation could consume 35 and only 34 will be left for the next cycle which is insufficient to guarantee correct operation. To avoid this situation new data must be added when 35+34 bits are in the loop so 35+34+64=133 bits in the loop. To indicate the number of valid bits only 7 bits are needed because the most significant 35 are always valid and this signal needs to indicate how many bits are valid in the least significant 98 bits.

The register 210 applies 35 bits to the main decoder 212. This deconstructs the compressed data signal to determine how many bytes are represented by the current codeword, whether that uncompressed word was compressed as a match, a miss or a run length code. The decoder provides at least some of the following signals as appropriate:

A single bit run length detected signal

An eight bit Count signal representing the length of the run

A four bit Location signal (relating to a 16 entry dictionary, again for simplicity of explanation)

A six bit Match Type signal

A 32 bit Literal Data signal

A 5 bit mask signal

A single bit Full Hit signal.

With the exception of the Run Length detected signal and the run length Count signal these are all supplied over respective busses to an RLI decoding register. This register is provided to delay the signals by one decompression cycle to synchronise with the Run Length decoding circuitry. It performs a function analogous to the pipeline employed in the compressor. After having been delayed by one decompression cycle these signals are supplied unaltered to the RLI Decoding Control Unit 216.

The RLI Decoding Control Unit is also connected to a Decompressor Run Length Internal (DRLI) Counter 218. The RLI Decoding Control Unit 216 provides a single bit Count Enable signal to the DRLI Counter and receives a single bit End Count signal from the DRLI Counter. The DRLI Counter is further provided with the eight bit RLI Count signal from the Main Decoder 212. Both the DRLI Counter 218 and the RLI Decoding and Control Unit 216 are supplied with the single bit RL Detected signal from the Main Decoder.

The RLI Decoding Control Unit 216 supplies the 4 bit Location signal and the one bit Full Hit signal to a 4-to-16 decoder 222

The 4-to-16 Decoder converts the dictionary location into a one of 16 signal and the 16 lines are supplied to both a Decompression Out_of_Date Adaption (DODA) logic 220 and to a Pointer Array 226. The DODA logic provides a 16 bit Select Write signal to Move Generator Logic 224 and to the Pointer Array 226. The Move Generation Logic 224 generates a 16 bit Move Control signal which is fed to the Pointer Array 226 and is also fed back to the DODA logic. The Pointer Array generates a 4 bit signal address write_a which is fed to a Sync Register 228 and also back to the Pointer Array. This is done because the address has to be loaded at the top of the dictionary while the rest move down one location. The addresses in the pointer array during decompression move the same way than the data in the CAM during compression. The Pointer Array also generates a 4 bit Read Address signal which is fed to an Address Equal circuit 230. The Sync Register 228 also provides a 4 bit signal address write_b to the Address Equal circuit 230. The address Equal Circuit provides a 4 bit Write Address signal and a 4 bit signal address write_c to a RAM Data Dictionary 232.

The RAM Data Dictionary is both addressed and updated by the elements 220 to 230 so that the contents of the dictionary are the same as those of the CAM during compression. It is not necessary to use CAM for the decompressor because it is used to provide as output the contents of one dictionary location rather than search the whole dictionary as must be done at the compressor. Because RAM is used and not CAM the entries in the dictionary cannot be moved easily and so a pointer system is used to address the dictionary entries.

The RAM Data Dictionary is associated with a RAM Mask Dictionary that is the same length as the RAM Data Dictionary and is four bits wide. Its purpose is analogous to that of the CAM Mask Dictionary in the compressor.

Multiplexer 236 selects between the output of the Data Dictionary or the Mask Dictionary together with the outputs of Temporary Regsiter 242. The temporary register is needed because under some circumstances the required data has not yet been written in the RAM but it is present in the RAM data bus. The register is used to temporarily latch the data that is being written in the RAM. The output of the multiplexer 236 is coupled to Output Tuple Assembler 238 which in turn feeds Assembling Unit 244 and Output Buffer 246 to provide an uncompressed output data stream 248.

FIG. 6 shows a block schematic diagram of a compressor in accordance with the invention and a decompressor according to the invention on the same semiconductor chip. To save space they may share a dictionary which will be a CAM. Duplex operation will not be possible if a dictionary is shared.

The invention is applicable to a number of applications within computer systems and networks. Applications include:

Compression of data being transferred between remote computers

Compression of data being transferred over a public network such as the internet

Compression of data for transmission and storage in a data warehouse

Compression of data for local storage in some type of permanent or semi-permanent storage system

The invention can find application when a reduction in data volume is required because memory is costly, or when power consumption or weight or volume are critical to product feasibility; and when reduction in bandwidth allows cost saving in cabling or faster transmission at fixed bandwidth.

1. A method of compressing digital data comprising a plurality of symbols, the method comprising parsing the digital data into tuples which terminate after an integer number of symbols or in response to the occurrence of a predetermined symbol in the digital data, comparing each tuple with a plurality of entries in a dictionary and replacing the tuple with a dictionary location in response to a match between the tuple and the entry at that dictionary location.

2. A method as claimed in claim 1, wherein the match between the tuple and the entry in the dictionary can comprise a match of fewer than the number of symbols in the tuple.

3. A method as claimed in claim 1, wherein the tuple is only compared with dictionary entries containing the same number of symbols as the tuple.

4. A method as claimed in claim 1, wherein the predetermined symbol represents a space character.

5. A method as claimed in claim 1, wherein a tuple that comprises a single occurrence of the predetermined symbol is replaced by a code.

6. A method as claimed in claim 5 wherein the code comprises two bits of data.

7. A method as claimed in claim 1, wherein the dictionary is updated in response to the tuples of digital data.

8. A method as claimed in claim 1, wherein a recurrent sequence of symbols in the incoming data is compressed by accumulating repetitive dictionary locations.

9. A digital data compressor for compressing digital data comprising a plurality of symbols, the compressor comprising: a parser responsive to an integer number of symbols or to the occurrence of a predetermined symbol in the digital data for dividing the digital data into tuples, a dictionary for comparing a tuple with a plurality of entries and logic for replacing the tuple with a dictionary location in response to a match between the tuple and the entry at that dictionary location.

10. A compressor as claimed in claim 9, wherein the match between the tuple and the entry in the dictionary can comprise a match of fewer than the number of symbols in the tuple.

11. A compressor as claimed in claim 9, wherein the dictionary is adapted to compare a tuple with entries containing the same number of symbols as the tuple.

12. A compressor as claimed in claim 9, wherein the predetermined symbol represents a space character.

13. A compressor as claimed in claim 9, further comprising logic responsive to a single occurrence of the predetermined symbol for replacing that symbol by a code.

14. A compressor as claimed in claim 13 wherein the code comprises two bits of data.

15. A compressor as claimed in claim 9, further comprising logic for updating the dictionary in response to the tuples of digital data.

16. A compressor as claimed in claim 9, further comprising logic responsive to repetitive dictionary locations to further compress recurrent sequence of symbols in the incoming data for accumulating these repetitive dictionary locations.

17. A method of decompressing digital data representing a plurality of symbols, the method comprising determining a quantity of the digital data that corresponds to a tuple of the original data which tuple terminates after an integer number of symbols or in response to the occurrence of a predetermined symbol in the original data, and retrieving symbols from a dictionary in response to digital data indicating that a dictionary match occurred

18. A method as claimed in claim 17, wherein a code representing a single occurrence of the predetermined symbol is replaced by the predetermined symbol.

19. A method as claimed in claim 1, wherein an accumulation of repetitive dictionary locations are replaced by the appropriate number of dictionary entries.

20. A method as claimed in claim 17, further responsive to compressed tuples in which a predetermined symbol is present but not explicitly coded.

21. A decompressor for decompressing digital data representing a plurality of symbols, the decompressor comprising logic for determining a quantity of the digital data that corresponds to a tuple of the original data which tuple terminates after an integer number of symbols or in response to the occurrence of a predetermined symbol in the original data, and logic for retrieving symbols from a dictionary in response to digital data indicating that a dictionary match occurred

22. A semiconductor integrated circuit comprising a digital data compressor and decompressor for compressing and decompressing digital data comprising a plurality of symbols, the compressor comprising: a parser responsive to an integer number of symbols or to the occurrence of a predetermined symbol in the digital data for dividing the digital data into tuples, a dictionary for comparing a tuple with a plurality of entries and logic for replacing the tuple with a dictionary location in response to a match between the tuple and the entry at that dictionary location and the decompressor comprising logic for determining a quantity of the digital data that corresponds to a tuple of the original data which tuple terminates after an integer number of symbols or in response to the occurrence of a predetermined symbol in the original data, and logic for retrieving symbols from a dictionary in response to digital data indicating that a dictionary match occurred

23. A compressed data signal adapted to reconstitute original digital data comprising a plurality of symbols, the compressed data signal comprising a plurality of discrete sections each corresponding to an integer number of symbols in the original digital data, each discrete section of the compressed data signal comprising an indication of whether the corresponding symbols matched a dictionary entry, an indication of the number of symbols represented by the discrete section and any symbols not present in the dictionary.
